(19) United States
(12) Patent Application Publication
(10) Pub. No.: US 2020/0219331 A1
(43) Pub. Date: Jul. 9, 2020

(54) INFORMATION PROCESSING APPARATUS, INFORMATION PROCESSING METHOD, AND NON-TRANSITORY STORAGE MEDIUM

(71) Applicant: NEC CORPORATION, Tokyo (JP)

(72) Inventors: Itaru NISHIOKA, Tokyo (JP); Yuta ASHIDA, Tokyo (JP); Michihiko YUSA, Tokyo (JP); Takeshi NAKAJIMA, Tokyo (JP)

(73) Assignee: NEC CORPORATION, Tokyo (JP)

(21) Appl. No.: 16/633,013

(22) PCT Filed: Jun. 27, 2018
(86) PCT No.: PCT/JP2018/024298

§ 371 Date: Jan. 22, 2020

(30) Foreign Application Priority Data
Jul. 26, 2017 (JP) 2017-144638

(51) Int. Cl. G07B 15/06; G08G 1/01; G06Q 50/30

(52) U.S. Cl. CPC G07B 15/06; G06Q 2240/00; G06Q 50/30; G08G 1/01

(57) ABSTRACT

According to the present invention, there is provided an information processing apparatus (30) of a second administrator, the apparatus including: a first obtainment unit (31) that obtains first information collected by a first information collection apparatus installed over a first road managed by a first administrator; a second obtainment unit (32) that obtains second information collected by a second information collection apparatus installed over a second road managed by the second administrator; and a notification unit (33) that notifies the first administrator of at least one of the first information and information detected on the basis of the first information.

### TECHNICAL FIELD

The present invention relates to an information processing apparatus, an information processing system, an information processing method, and a program.

### BACKGROUND ART

Patent Document 1 discloses an invention for optimizing traffic volumes on both of a toll road and a general road. In the present invention, traffic information including an average required time is obtained for each section, and a traffic congestion scale is computed by comparing the traffic information with an average traffic time. A traffic congestion coefficient is computed by subtracting a traffic congestion scale of the general road from a traffic congestion scale of the toll road, and a discount and addition rate for the traffic congestion coefficient is determined and notified to vehicles.

Patent Document 2 discloses an invention in which it is determined whether a predetermined event occurs on a road on the basis of a result of image processing, and information on the determined event is distributed to users of a road.

### RELATED DOCUMENT

### Patent Document

[Patent Document 1] Japanese Unexamined Patent Application Publication No. 2015-106278

[Patent Document 2] Japanese Unexamined Patent Application Publication No. 2002-230679

### SUMMARY OF THE INVENTION

### Technical Problem

On the basis of traffic conditions of both of a toll road and a general road, it is possible to effectively optimize a traffic volume of each road by guiding a vehicle to the toll road or to the general road. Meanwhile, in a case where a company which manages the toll road is different from a company which manages the general road, each company can obtain information indicating a situation of the road of itself, but cannot obtain information indicating a situation of the road managed by the other company, in some cases. For example, for this reason, it is difficult to grasp traffic conditions on both of the toll road and the general road and optimize the traffic volume on each road.

The present invention provides a technology for optimizing a traffic volume of each road by grasping traffic conditions of both of a toll road and a general road, in which both a company which manages the toll road and a company which manages the general road obtain advantages.

### Solution to Problem

According to the present invention, there is provided an information processing apparatus of a second administrator, the apparatus including: a first obtainment unit that obtains first information collected by a first information collection apparatus installed over a first road managed by a first administrator; a second obtainment unit that obtains second information collected by a second information collection apparatus installed over a second road managed by the second administrator; and a notification unit that notifies the first administrator of at least one of the first information and information detected on the basis of the first information.

In addition, according to the present invention, there is provided an information processing system including: a first information collection apparatus installed over a first road managed by a first administrator; a second information collection apparatus installed over a second road managed by a second administrator; and an information processing apparatus of the second administrator, in which the first information collection apparatus transmits collected first information to the information processing apparatus, the second information collection apparatus transmits collected second information to the information processing apparatus, and the information processing apparatus notifies the first administrator of at least one of the first information and information detected on the basis of the first information.

In addition, according to the present invention, there is provided an information processing apparatus including: a first obtainment unit that obtains first information collected by a first information collection apparatus installed over a first road managed by a first administrator; a second obtainment unit that obtains second information collected by a second information collection apparatus installed over a second road managed by a second administrator; a detection unit that detects occurrence of a predetermined event on the first road on the basis of the first information; and a computation unit that computes, on the basis of the first information and the second information, at least one of a conversion rate of a traffic volume from the first road to the second road in a case where the occurrence of the predetermined event is notified to a notification target, a change in the conversion rate before and after the notification, a change in a traffic jam occurrence frequency before and after the notification, a change in a traffic jam situation before and after the notification, and a change in CO₂ concentration before and after the notification.

In addition, according to the present invention, there is provided an information processing method executed by a computer of a second administrator, the method comprising: a first obtainment step of obtaining first information collected by a first information collection apparatus installed over a first road managed by a first administrator; a second obtainment step of obtaining second information collected by a second information collection apparatus installed over a second road managed by the second administrator; and a notification step of notifying the first administrator of at least one of the first information and information detected on the basis of the first information.

In addition, according to the present invention, there is provided a program for causing a computer of a second administrator to function as: a first obtainment unit that obtains first information collected by a first information collection apparatus installed over a first road managed by a first administrator; a second obtainment unit that obtains second information collected by a second information collection apparatus installed over a second road managed by the second administrator; and a notification unit that notifies the first administrator of at least one of the first information and information detected on the basis of the first information.

In addition, according to the present invention, there is provided an information processing method caused by a computer, the method comprising: a first obtainment step of obtaining first information collected by a first information collection apparatus installed over a first road managed by a first administrator; a second obtainment step of obtaining second information collected by a second information collection apparatus installed over a second road managed by a second administrator; a detection step of detecting occurrence of a predetermined event on the first road on the basis of the first information; and a computation step of computing at least one of a conversion rate of a traffic volume from the first road to the second road in a case where the occurrence of the predetermined event is notified to a notification target, a change in the conversion rate before and after the notification, a change in a traffic jam occurrence frequency before and after the notification, a change in a traffic jam situation before and after the notification, and a change in CO₂ concentration before and after the notification, on the basis of the first information and the second information.

In addition, according to the present invention, there is provided a program for causing a computer to function as: a first obtainment unit that obtains first information collected by a first information collection apparatus installed over a first road managed by a first administrator; a second obtainment unit that obtains second information collected by a second information collection apparatus installed over a second road managed by a second administrator; a detection unit that detects occurrence of a predetermined event on the first road on the basis of the first information; and a computation unit that computes, on the basis of the first information and the second information, at least one of a conversion rate of a traffic volume from the first road to the second road in a case where the occurrence of the predetermined event is notified to a notification target, a change in the conversion rate before and after the notification, a change in a traffic jam occurrence frequency before and after the notification, a change in a traffic jam situation before and after the notification, and a change in CO₂ concentration before and after the notification.

### Advantageous Effects of Invention

The present invention realizes a technology for optimizing a traffic volume of each of a toll road and a general road by grasping traffic conditions of the both roads, in which both a company which manages the toll road and a company which manages the general road obtain advantages.

### BRIEF DESCRIPTION OF THE DRAWINGS

The above objects and other objects, features and advantages will become more apparent from the following description of the preferred example embodiments and the accompanying drawings.

FIG. 1 is a diagram for explaining an overview of an information processing system according to the present example embodiment.

FIG. 2 is a diagram illustrating an example of a hardware configuration of the information processing apparatus according to the present example embodiment.

FIG. 3 is an example of a functional block diagram of the information processing apparatus according to the present example embodiment.

FIG. 4 is a diagram for explaining a flow of information of the information processing system according to the present example embodiment.

FIG. 5 is an example of another functional block diagram of the information processing apparatus according to the present example embodiment.

FIG. 6 is an example of still another functional block diagram of the information processing apparatus according to the present example embodiment.

FIG. 7 is an example of still another functional block diagram of the information processing apparatus according to the present example embodiment.

### DESCRIPTION OF EMBODIMENTS

### First Example Embodiment

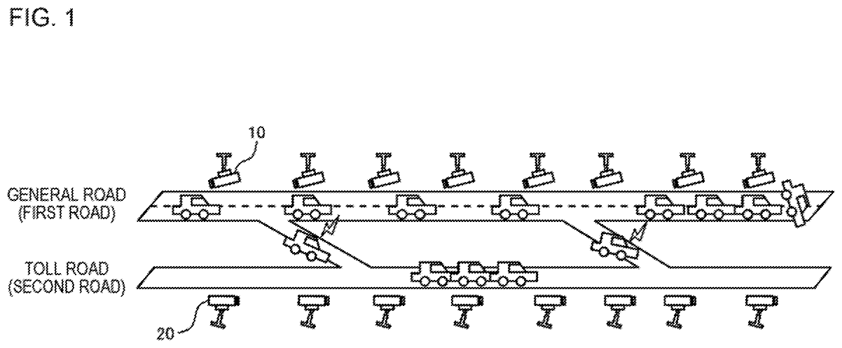

First, an overview of an information processing system according to the present example embodiment will be described with reference to FIG. 1. The information processing system includes a plurality of first information collection apparatuses 10, a plurality of second information collection apparatuses 20, and an information processing apparatus 30 (not shown in the drawings). Each of the plurality of first information collection apparatuses 10 and the information processing apparatus 30 are configured to be able to communicate with each other by any communication means. Further, each of the plurality of second information collection apparatuses 20 and the information processing apparatus 30 are configured to be able to communicate with each other by any communication means.

The first information collection apparatus 10, the second information collection apparatus 20, and the information processing apparatus 30 are all managed by the same company. In the present example embodiment, a second administrator who manages toll roads manages the first information collection apparatus 10, the second information collection apparatus 20, and the information processing apparatus 30. It should be noted that, the toll road may include a management lane. The management lane is, for example, a lane through which only vehicles with passengers equal to or more than a certain number can pass.

The first information collection apparatus 10 is installed over a first road. The first road is a general road and passing without a toll is allowed. A first administrator manages the first road. That is, the second administrator may install the first information collection apparatus 10 over the first road managed by the first administrator with permission of the first administrator.

The second information collection apparatus 20 is installed over a second road. The second road is a toll road, and it is necessary to pay a toll for passing. The second administrator manages the second road. That is, the second administrator installs the second information collection apparatus 20 over the second road managed by itself (the second administrator).

As shown in the drawing, a vehicle can move from the toll road to the general road or from the general road to the toll road.

The first information collection apparatus 10 and the second information collection apparatus 20 collect various types of information indicating traffic conditions. The collected information is transmitted to the information processing apparatus 30. For example, the first information collection apparatus 10 and the second information collection apparatus 20 may include sensors which detect a velocity of a vehicle passing through, a traffic volume (the amount of vehicles passing through a certain point per unit time), and the like. In addition, the first information collection apparatus 10 and the second information collection apparatus 20 may include roadside sensors for monitoring traffic conditions, and generate images (moving images and/or still images) indicating traffic conditions of the road. It should be noted that, the information collected by the first information collection apparatus 10 and the second information collection apparatus 20 is not limited to the examples described herein. For example, the information collection apparatus may be a sensor which performs measurement with a radio wave such as a loop coil, an image processing apparatus with a camera, an apparatus which performs measurement with a radio wave signal given from a vehicle such as DSRC, WiFi, Bluetooth (registered trademark). The information collection apparatus may include a sensor which measures concentration of CO₂.

The information processing apparatus 30 obtains information (hereinafter, first information) collected by the first information collection apparatus 10. In addition, the information processing apparatus 30 obtains information (second information) collected by the second information collection apparatus 20. On the basis of the first information and the second information, the information processing apparatus 30 can grasp traffic conditions of both of the general road and the toll road. In addition, the information processing apparatus 30 notifies the first administrator of at least one of the first information and information detected on the basis of the first information (for example, traffic conditions on the general road).

According to such an information processing system of the present example embodiment, the second administrator who manages the information processing apparatus 30 can grasp the traffic conditions on both of the general road and the toll road. On the basis of the traffic conditions of both of the toll road and the general road, it is possible to guide the vehicle to the toll road or to the general road as needed.

In a case where the first information collection apparatus 10 is not provided over a general road not managed by the second administrator, there is a possibility that the second administrator itself has a burden of installing the apparatus and maintaining the apparatus. Meanwhile, in this case, it is possible to appropriately guide the vehicle to the toll road on the basis of the traffic conditions on both the toll road and the general road. Accordingly, users of the toll road can be increased effectively, and as a result, income can be increased.

The first administrator needs to allow the second administrator to install the first information collection apparatus 10 over the general road. Meanwhile, the second administrator appropriately guides the vehicle to the toll road on the basis of the traffic conditions on both the toll road and the general road, so that an advantage such as avoiding a traffic jam on the general road can be obtained. Further, the first administrator can obtain the first information and the like collected by the first information collection apparatus 10 managed by the second administrator, from the second administrator. That is, the first administrator can obtain the first information indicating the traffic condition of the general road managed by the first administrator and the like via the first information collection apparatus 10 managed by the second administrator.

In this manner, according to the present example embodiment, it is possible to bring advantages to both of the company which manages the toll road and the company which manages the general road. For this reason, it is expected that the introduction of this system will be accepted by both companies. As a result, even in a case where the company which manages the toll road and the company which manages the general road are different from each other, the traffic volume of each road can be optimized on the basis of the traffic conditions of both of the toll road and the general road.

Hereinafter, a configuration of the information processing apparatus 30 will be described in detail. First, an example of a hardware configuration of the information processing apparatus 30 will be described. Each functional unit included in the information processing apparatus 30 of the present example embodiment is configured by any combination of hardware and software based on a central processing unit (CPU) of any computer, a memory, a program loaded in the memory, a storage unit (in addition to the program stored from a stage of shipping the apparatus in advance, a program downloaded from a storage medium such as a compact disc (CD) or a server on the internet) such as a hard disc storing the program, and a network connection interface. Those skilled in the art understand that there are various modification examples to the configuration method thereof and the apparatus.

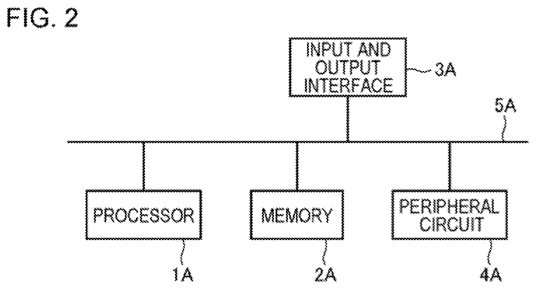

FIG. 2 is a block diagram illustrating a hardware configuration of the information processing apparatus 30 of the present example embodiment. As illustrated in FIG. 1, the information processing apparatus 30 includes a processor 1A, a memory 2A, an input and output interface 3A, a peripheral circuit 4A, and a bus 5A. The peripheral circuit 4A includes various modules. It should be noted that, the information processing apparatus 30 may be configured with a plurality of apparatuses physically and/or logically divided. In this case, each of the plurality of apparatuses may include the processor 1A, the memory 2A, the input and output interface 3A, the peripheral circuit 4A, and the bus 5A.

The bus 5A is a data transmission path through which the processor 1A, the memory 2A, the peripheral circuit 4A and, the input and output interface 3A transmit and receive data to and from one another. The processor 1A is an arithmetic processing apparatus such as a CPU or a graphics processing unit (GPU), for example. The memory 2A is a memory such as a random access memory (RAM) or a read only memory (ROM), for example. The input and output interface 3A includes an interface for obtaining information from an input device (for example, a keyboard, a mouse, a microphone, a physical key, a touch panel display, a code reader, or the like), an external apparatus, an external server, an external information collection apparatus, and the like and an interface for outputting information from an output device (for example, a display, a speaker, a printer, an emailer, or the like), the external apparatus, the external server, and the like. The processor 1A can output a command to each module and perform a calculation based on a calculation result thereof.

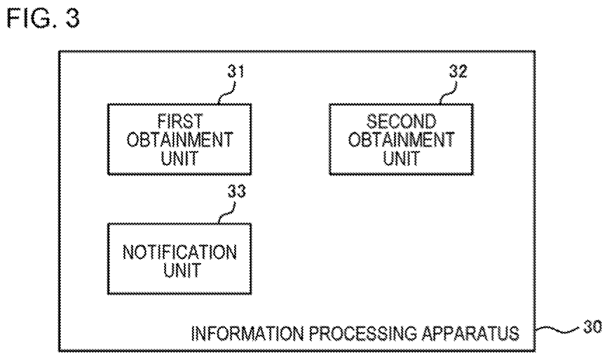

Next, a functional configuration of the information processing apparatus 30 will be described. FIG. 3 illustrates an example of a functional block diagram of the information processing apparatus 30. As shown in the drawing, the information processing apparatus 30 includes a first obtainment unit 31, a second obtainment unit 32, and a notification unit 33. As described above, the information processing apparatus 30 is an apparatus managed by the second administrator.

The first obtainment unit 31 obtains the first information collected by the first information collection apparatus 10, from the first information collection apparatus 10. The first information is information indicating a traffic condition of the general road. Examples of the first information include a velocity of the vehicle passing through the general road, a traffic volume of the general road, an image of the general road, a time required to reach a determined point, CO₂ concentration, and the like, but the example is not limited thereto.

The first obtainment unit 31 preferably obtains the first information collected by the first information collection apparatus 10 with a smaller time loss from a time of collection. The first information collection apparatus 10 may transmit the collected information to the information processing apparatus 30 by a real-time process, or may collectively transmit information collected for each cycle with a small time cycle to the information processing apparatus 30.

The second obtainment unit 32 obtains the second information collected by the second information collection apparatus 20, from the second information collection apparatus 20. The second information is information indicating a traffic condition of the toll road. Examples of the second information include a velocity of the vehicle passing through the toll road, a traffic volume of the toll road, an image of the toll road, a time required to reach a determined point, CO₂ concentration, and the like, but the example is not limited thereto.

The second obtainment unit 32 preferably obtains the second information collected by the second information collection apparatus 20 with a smaller time loss from a time of collection. The second information collection apparatus 20 may transmit the collected information to the information processing apparatus 30 by a real-time process, or may collectively transmit information collected for each cycle with a small time cycle to the information processing apparatus 30.

The notification unit 33 notifies the first administrator of at least one of the first information and information indicating traffic conditions of the general road obtained on the basis of the first information (hereinafter, “first condition information”). The first condition information may be a traffic condition detected by a detection unit 34 to be described in a second example embodiment or information computed by a computation unit 35. Although details will be described below, the detection unit 34 detects occurrence of a traffic jam on the general road. Further, the computation unit 35 computes various types of information indicating the traffic conditions of the general road and the toll road.

It should be noted that, the first information may include an information collection position and an information collection date and time. Further, the first condition information may include the information collection position and an information collection date and time of the first information used for detection and computation of the traffic condition.

For example, the notification unit 33 may transmit at least one of the first information and the first condition information to a terminal managed by the first administrator through any communication means. For example, the notification unit 33 may use address information on the Internet registered in advance (for example, an internet protocol (IP) address, an e-mail address, and the like) as a destination, and transmit at least the first information and the first condition information.

The notification unit 33 may collectively notify the first administrator of at least one of the first information and the first condition information obtained for each cycle at a predetermined notification cycle (for example, every hour, every 30 minutes, every 15 minutes). In addition, when the first condition information indicating occurrence of a traffic jam on the general road is obtained, the notification unit 33 may notify the first administrator of the first condition information and the first information related thereto. The related first information is, for example, the first information used for detecting occurrence of a traffic jam, the first information obtained at a traffic jam occurrence location after the traffic jam occurs and before the traffic jam is cleared up, or the like. The occurrence of the traffic jam and the clearing of the traffic jam are detected by the detection unit 34 to be described below.

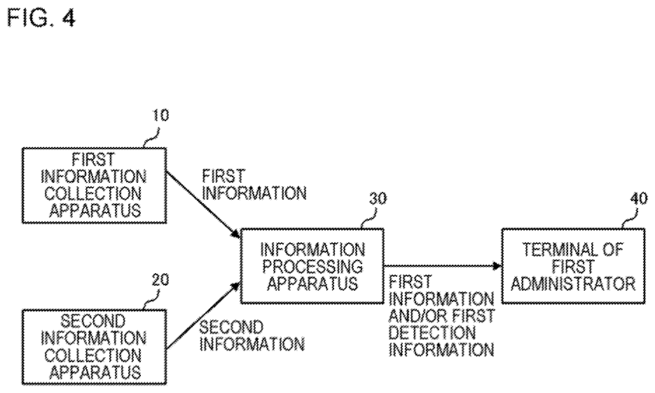

Next, an example of a flow of information of the information processing system of the present example embodiment will be described with reference to FIG. 4.

The first information collection apparatus 10 transmits the collected first information to the information processing apparatus 30. The first information is information indicating a traffic condition of the general road. The first information collection apparatus 10 repeats the process of transmitting the first information to the information processing apparatus 30.

The second information collection apparatus 20 transmits the collected second information to the information processing apparatus 30. The second information is information indicating a traffic condition of the toll road. The second information collection apparatus 20 repeats the process of transmitting the second information to the information processing apparatus 30.

The information processing apparatus 30 accumulates the first information and the second information in a storage apparatus. On the basis of this information, it is possible to grasp the traffic condition of the general road and the traffic condition of the toll road.

The information processing apparatus 30 transmits at least one of the first information and the information detected on the basis of the first information (the first condition information) to a terminal 40 of the first administrator.

According to the information processing system of the present example embodiment described above, the second administrator who manages the information processing apparatus 30 can obtain the first information and the second information and grasp the traffic conditions on both of the general road and the toll road. On the basis of the traffic conditions of both of the toll road and the general road, it is possible to guide the vehicle to the toll road or to the general road as needed.

In a case where no apparatus for traffic management is provided over the general road not managed by the second administrator, the second administrator has a burden of installing the first information collection apparatus 10 and maintaining the apparatus. Meanwhile, it is possible to appropriately guide the vehicle to the toll road on the basis of the traffic conditions on both the toll road and the general road. Accordingly, users of the toll road can be increased effectively, and as a result, income can be increased.

The first administrator needs to allow the second administrator to install the first information collection apparatus 10 over the general road. Meanwhile, the second administrator appropriately guides the vehicle to the toll road on the basis of the traffic conditions on both the toll road and the general road, so that an advantage such as avoiding a traffic jam on the general road can be obtained. Further, the first administrator can obtain the first information and the like collected by the first information collection apparatus 10 managed by the second administrator, from the second administrator. That is, the first administrator can obtain the first information indicating the traffic condition of the general road managed by the first administrator and the like via the first information collection apparatus 10 managed by the second administrator.

In this manner, according to the present example embodiment, it is possible to bring advantages to both of the company which manages the toll road and the company which manages the general road. For this reason, it is expected that the introduction of this system will be accepted by both companies. As a result, even in a case where the company which manages the toll road and the company which manages the general road are different from each other, the traffic volume of each road can be optimized on the basis of the traffic conditions of both of the toll road and the general road.

It should be noted that, in the above description, the first road is set as the general road and the second road is set as the toll road, and the second administrator which manages the second road (the toll road) manages the first information collection apparatus 10, the second information collection apparatus 20, and the information processing apparatus 30. As a modification example, the first road may be set as the toll road and the second road may be set as the general road, and the second administrator which manages the second road (the general road) may manage the first information collection apparatus 10, the second information collection apparatus 20, and the information processing apparatus 30. The modification example can be applied to all the following example embodiments. Also in a case of the modification example, the same advantageous effect can be realized.

### Second Example Embodiment

In an information processing system according to the present example embodiment, a configuration of the information processing apparatus 30 is different from that of the first example embodiment. Other configurations are the same as the first example embodiment.

The information processing apparatus 30 is different from that of the first example embodiment in that the information processing apparatus 30 includes a unit which detects occurrence of a predetermined event on the general road on the basis of the first information and a unit which computes various types of information indicating traffic conditions on the general road and the toll road on the basis of the first information and the second information. Hereinafter, details will be described.

An example of a hardware configuration of the information processing apparatus 30 is the same as that of the first example embodiment.

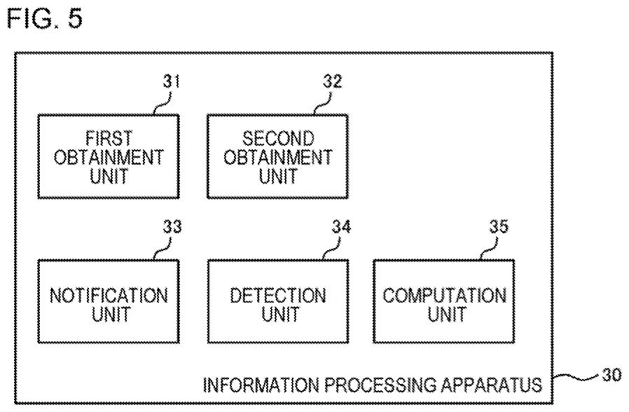

FIG. 5 is an example of a functional block diagram of the information processing apparatus 30 according to the present example embodiment. As shown in the drawing, the information processing apparatus 30 includes the first obtainment unit 31, the second obtainment unit 32, the notification unit 33, the detection unit 34, and the computation unit 35. Configurations of the first obtainment unit 31, the second obtainment unit 32, and the notification unit 33 are the same as those of the first example embodiment.

The detection unit 34 detects occurrence of a traffic jam (a predetermined event) on the general road on the basis of the first information. The detection unit 34 may further detect the clearing of the detected traffic jam. The occurrence of the traffic jam and the clearing of the traffic jam can be detected by using any technology on the basis of the first information. For example, a spatial average velocity may be computed, and it may be determined that a traffic jam occurs when a state in which the value is less than a reference value continues for a certain period of time or longer, and it is determined as a normal state (no traffic jam) otherwise. It should be noted that, this means is only an example.

On the basis of the first information and the second information, the computation unit 35 computes various types of information indicating traffic conditions of both of the general road and the toll road. For example, in a case where occurrence of a traffic jam on the general road (occurrence of a predetermined event) is notified to a notification target, the computation unit 35 computes at least one of a conversion rate of a traffic volume from the general road to the toll road, a change in the conversion rate before and after the notification, a change in a traffic jam occurrence frequency of the general roads and/or the toll road before and after the notification, a change in a traffic jam situation on the general road and/or the toll road before and after the notification, and a change in CO₂ concentration on the general road and/or the toll road before and after the notification.

The computation unit 35 can compute the conversion rate after the notification on the basis of the first information and the second information obtained after the notification. In addition, on the basis of the first information and the second information obtained before the notification and the first information and the second information obtained after the notification, the computation unit 35 can compute a change in the conversion rate, a change in the traffic jam occurrence frequency, a change in the traffic jam situation, and a change in the CO₂ concentration.

The notification target of the occurrence of the predetermined event is a user of the road. The notification of the occurrence of the predetermined event (hereinafter, “event occurrence notification”) is performed, for example, by displaying information on a display apparatus installed over the road. The event occurrence notification may be performed by the first administrator or may be performed by the second administrator. In a case of being performed by the second administrator, for example, the information processing apparatus 30 and the display apparatus may be able to communicate with each other via a network such as the Internet or a dedicated line. When the detection unit 34 detects occurrence of a traffic jam on the general road, the information processing apparatus 30 may transmit a predetermined signal to the display apparatus in response thereto and display information indicating the occurrence of the traffic jam on the display apparatus. It should be noted that, the event occurrence notification may be performed by providing information using an information transmission means such as a radio, a television, a car navigation, and Internet news. In addition, contents of the event occurrence notification may include information on a traffic jam occurrence location, a traffic jam distance, a traffic jam time, a traffic condition of the toll road (whether or not there is a traffic jam or the like), information on regulation due to the occurrence of an accident or regulation due to construction work, and the like.

The conversion rate is used to quantify a ratio of the traffic volume on the general road and the traffic volume on the toll road. That is, the conversion rate indicates a ratio of the traffic volume on the toll road when a total traffic volume including the traffic volume on the general road and the traffic volume on the toll road is 1. For example, the computation unit 35 computes a traffic volume of each of the general road and the toll road in each time slot by using each piece of the first information and the second information, and computes a conversion rate by using the computed traffic volumes. The conversion rate of each time slot can be computed from the total accumulated traffic volume at a certain time interval by using the traffic volume of the toll road at the same time interval.

Further, on the basis of the conversion rate computed on the basis of the first information and the second information before the event occurrence notification and the conversion rate computed on the basis of the first information and the second information after the event occurrence notification, the computation unit 35 can compute a change in the conversion rate before and after the event occurrence notification. For example, an increase rate may be computed by dividing a difference obtained by subtracting (conversion rate before event occurrence notification) from (conversion rate after event occurrence notification) by (conversion rate before event occurrence notification).

The traffic jam occurrence frequency indicates the number of occurrences of the traffic jam per unit time. On the basis of the number of occurrences of the traffic jam on the general road computed on the basis of the first information before the event occurrence notification and the number of occurrences of the traffic jam on the general road computed on the basis of the first information after the event occurrence notification, the computation unit 35 can compute a change in the traffic jam occurrence frequency of the general road before and after the event occurrence notification. For example, a decrease rate may be computed by dividing a difference obtained by subtracting (traffic jam occurrence frequency after event occurrence notification) from (traffic jam occurrence frequency before event occurrence notification) by (traffic jam occurrence frequency before event occurrence notification).

In the same manner, on the basis of the number of occurrences of the traffic jam on the toll road computed on the basis of the second information before the event occurrence notification and the number of occurrences of the traffic jam on the toll road computed on the basis of the second information after the event occurrence notification, the computation unit 35 can compute a change in the traffic jam occurrence frequency of the toll road before and after the event occurrence notification. For example, the increase rate may be computed by dividing a difference obtained by subtracting (traffic jam occurrence frequency before event occurrence notification) from (traffic jam occurrence frequency after event occurrence notification) by (traffic jam occurrence frequency before event occurrence notification).

The traffic jam situation is, for example, a length of a distance at which a traffic jam occurs (a traffic jam distance), a length of a time when the traffic jam occurs (a traffic jam time), or the like. On the basis of the traffic jam situation on the general road computed on the basis of the first information before the event occurrence notification and the traffic jam situation (for example, a statistical value of a traffic jam distance or a traffic jam time of an occurring traffic jam (a maximum value, a minimum value, an average value, a mode value, a median value, or the like)) on the general road computed on the basis of the first information after the event occurrence notification, the computation unit 35 can compute a change in the traffic jam situation on the general road before and after the event occurrence notification. For example, a decrease rate may be computed by dividing a difference obtained by subtracting (traffic jam distance after event occurrence notification) from (traffic jam distance before event occurrence notification) by (traffic jam distance before event occurrence notification). In addition, a decrease rate may be computed by dividing a difference obtained by subtracting (traffic jam time after event occurrence notification) from (traffic jam time before event occurrence notification) by (traffic jam time before event occurrence notification).

In the same manner, on the basis of the traffic jam situation on the toll road computed on the basis of the second information before the event occurrence notification and the traffic jam situation on the toll road computed on the basis of the second information after the event occurrence notification, the computation unit 35 can compute a change in the traffic jam situation on the toll road before and after the event occurrence notification. For example, the increase rate may be computed by dividing a difference obtained by subtracting (traffic jam distance before event occurrence notification) from (traffic jam distance after event occurrence notification) by (traffic jam distance before event occurrence notification). In addition, the increase rate may be computed by dividing a difference obtained by subtracting (traffic jam time before event occurrence notification) from (traffic jam time after event occurrence notification) by (traffic jam time before event occurrence notification).

Further, on the basis of the CO₂ concentration of the general road obtained from the first information before the event occurrence notification and the CO₂ concentration of the general road obtained from the first information after the event occurrence notification, the computation unit 35 can compute a change in the CO₂ concentration of the general road before and after the event occurrence notification. For example, a decrease rate may be computed by dividing a difference obtained by subtracting (CO₂ concentration after event occurrence notification) from (CO₂ concentration before event occurrence notification) by (CO₂ concentration before event occurrence notification).

In the same manner, on the basis of the CO₂ concentration of the toll road obtained from the second information before the event occurrence notification and the CO₂ concentration of the toll road obtained from the second information after the event occurrence notification, the computation unit 35 can compute a change in the CO₂ concentration of the toll road before and after the event occurrence notification. For example, the increase rate may be computed by dividing a difference obtained by subtracting (CO₂ concentration before event occurrence notification) from (CO₂ concentration after event occurrence notification) by (CO₂ concentration before event occurrence notification).

Further, the computation unit 35 may compute income of the second administrator obtained by notifying the notification target of the occurrence of the traffic jam on the general road on the basis of the computed conversion rate. For example, by multiplying a current total traffic volume, computed by adding the current traffic volume on the general road and the current traffic volume on the toll road, by the computed conversion rate, the computation unit 35 may compute a traffic volume on the toll road after the occurrence of the traffic jam is notified to the notification target. By multiplying the computed traffic volume on the toll road by a toll of the toll road, the income may be computed.

In addition, the computation unit 35 may compute the income by multiplying the toll of the toll road by an increase in the traffic volume on the toll road before and after the occurrence of the traffic jam on the general road is notified to the notification target. Further, the computation unit 35 may compute an amount obtained by multiplying the computed income of the second administrator by a coefficient less than 1 as an amount which the second administrator pays to the first administrator.

Further, the computation unit 35 may compute income of the second administrator obtained by notifying the notification target of the occurrence of the traffic jam, in the following manner. For example, between the first administrator and the second administrator, a determination may be made in which the first administrator pays the second administrator according to a change in the traffic jam occurrence frequency of the general road before and after the event occurrence notification, a change in the traffic jam situation on the general road before and after the event occurrence notification, or a change in the CO₂ concentration of the general road before and after the event occurrence notification. As the contents of the determination, it is considered that a larger price is paid as the decrease rate of the traffic jam occurrence frequency of the general road before and after the event occurrence notification is greater, as the decrease rate of the traffic jam distance of the general road before and after the event occurrence notification is greater, as the decrease rate of the traffic jam time of the general road before and after the event occurrence notification is greater, and as the decrease rate of the CO₂ concentration of the general road before and after the event occurrence notification.

The computation unit 35 may compute the income of the second administrator (the price) according to the determination. In a case where the contents of the determination are as described above, the computation unit 35 computes a greater price as the decrease rate of the traffic jam occurrence frequency of the general road before and after the event occurrence notification is greater. In addition, the computation unit 35 computes a greater price as the decrease rate of the traffic jam distance or the traffic jam time of the general road before and after the event occurrence notification is greater. Further, the computation unit 35 computes a greater price as the decrease rate of the CO₂ concentration of the general road before and after the event occurrence notification is greater.

According to the information processing system of the present example embodiment described above, the same advantageous effect as the first example embodiment can be realized.

Further, according to the present example embodiment, the information processing apparatus 30 of the second administrator can detect occurrence of a traffic jam on the general road managed by the first administrator. The second administrator can notify users of the road of the occurrence of the traffic jam on the general road. Accordingly, the second administrator can appropriately guide vehicles to the toll road when the traffic jam occurs on the general road, and increase income. The first administrator can benefit from avoiding the traffic jam on the general road.

The information processing apparatus 30 can compute various types of information. For example, the information processing apparatus 30 can compute the conversion rate of the traffic volume from the first road to the second road in a case where the occurrence of the traffic jam on the general road is notified to the notification target or a change in the conversion rate before and after the notification to the notification target. In addition, the information processing apparatus 30 can compute income of the second administrator obtained by the notification to the notification target. On the basis of these, the second administrator can grasp cost-effectiveness and the like by introducing the information processing system.

Further, the information processing apparatus 30 can compute a change in the traffic jam occurrence frequency of the general road and/or the toll road before and after the notification to the notification target, a change in the traffic jam situation on the general road and/or the toll road before and after the notification to the notification target, a change in the CO₂ concentration of the general road and/or the toll road before and after the notification to the notification target, and the like. On the basis of these, it is possible to grasp the effects to the general road by the notification to the notification target. By notifying these to the first administrator, the first administrator can grasp the effect and the like brought about by allowing that the information processing system is introduced, and specifically, by allowing that the first information collection apparatus 10 is installed over the general road.

### Third Example Embodiment

In an information processing system according to the present example embodiment, a configuration of the information processing apparatus 30 is different from those of the first and the second example embodiments. Other configurations are the same as the first and the second example embodiments.

In the present example embodiment, a toll of the toll road is variable. The information processing apparatus 30 is different from that of the first and the second example embodiments in that the information processing apparatus 30 includes a unit which determines a toll of the toll road on the basis of the first information and the second information, a unit which notifies the notification target of the determined toll, and a unit which computes various types of information indicating traffic conditions on the general road and the toll road on the basis of the first information, the second information, and the toll. Hereinafter, details will be described.

An example of a hardware configuration of the information processing apparatus 30 is the same as those of the first and the second example embodiments.

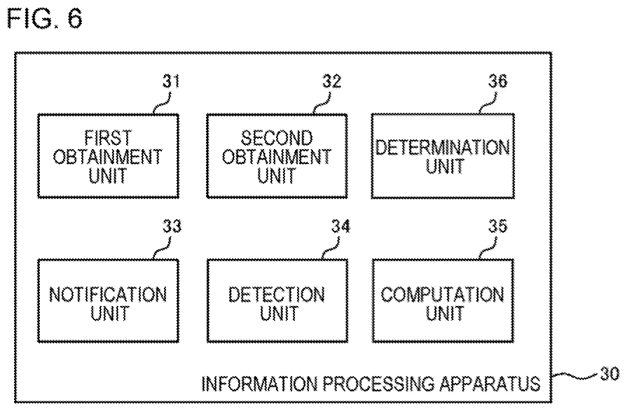

FIG. 6 is an example of another functional block diagram of the information processing apparatus 30 according to the present example embodiment. As shown in the drawing, the information processing apparatus 30 includes the first obtainment unit 31, the second obtainment unit 32, the notification unit 33, the detection unit 34, the computation unit 35, and a determination unit 36. Configurations of the first obtainment unit 31, the second obtainment unit 32, the notification unit 33, and the detection unit 34 are the same as those of the first and the second example embodiments.

The determination unit 36 determines a toll of the toll road on the basis of the first information and the second information. For example, when the detection unit 34 detects occurrence of a traffic jam on the general road, the determination unit 36 determines an optimum toll of the toll road accordingly. The determination unit 36 determines the toll for the toll road which maximizes income of the second administrator.

Here, an example of a process of determining a toll will be described. For example, the computation unit 35 described in the second example embodiment has a machine learning function, and uses a prediction model for estimating the conversion rate so as to obtain an appropriate “a toll of a toll road”.

Here, the machine learning function predicts the conversion rate for the toll by using an estimation model in which a combination of the first information and the second information is an explanatory variable and the conversion rate is an objective variable. Examples of the estimation model include multiple regression analysis, neural network, hidden Markov model, and the like, but are not limited thereto. Training data used for machine learning may be the past actual value, that is, the actual values of the first information, the second information, and the conversion rate and the toll of the toll road in a case where the occurrence of the traffic jam on the general road is notified to the notification target in the past. It should be noted that, the explanatory variable may include the month, day of the week, time, and weather when a traffic jam occurs, a traffic jam occurrence location, and the like.

When the detection unit 34 detects occurrence of a traffic jam on the general road, the computation unit 35 inputs a combination (which may further include other values such as the month, the day of the week, the time, and the weather when the traffic jam occurs, the traffic jam occurrence location, and the like) of the collected first information, second information, and toll of the toll road to the estimation model, and computes the conversion rate. At this time, the computation unit 35 creates a plurality of cases with different “tolls of toll road” in the explanatory variable, and computes the conversion rate for each case. The values of other explanatory variables of the plurality of cases may be common.

The determination unit 36 computes income of the second administrator for each case on the basis of the conversion rate computed for each case. For example, by multiplying a current total traffic volume, computed by adding the current traffic volume on the general road and the current traffic volume on the toll road, by the computed conversion rate, the determination unit 36 computes a traffic volume on the toll road after the occurrence of the traffic jam and the toll of the toll road are notified to the notification target, for each case. Next, the determination unit 36 computes the income by multiplying the computed traffic volume of the toll road by the determined toll of the toll road for each case. The determination unit 36 determines the toll of the toll road that makes the income the largest as the toll of the toll road.

In the present example embodiment, when the detection unit 34 detects the occurrence of the traffic jam on the general road, the information processing apparatus 30 may cause the display apparatus to display information indicating the traffic jam occurrence and the toll of the toll road determined by the determination unit 36. It should be noted that, the notification to the notification target may be performed by providing information using an information transmission means such as a radio, a television, a car navigation, and Internet news. In addition, contents of the notification to the notification target may include information on a traffic jam occurrence location, a traffic jam distance, a traffic jam time, a traffic condition of the toll road (whether or not there is a traffic jam or the like), and the like.

According to the information processing system of the present example embodiment described above, the same advantageous effect as the first and the second example embodiments can be realized.

In addition, according to the information processing system of the present example embodiment, the toll of the toll road can be determined so as to maximize the income of the second administrator in response to detection of occurrence of the traffic jam on the general road. The second administrator can appropriately set the toll of the toll road when the traffic jam occurs on the general road, and thus increase income.

### Fourth Example Embodiment

In an information processing system according to the present example embodiment, a configuration of the information processing apparatus 30 is different from those of the first and the second example embodiments. Other configurations are the same as the first to the third example embodiments.

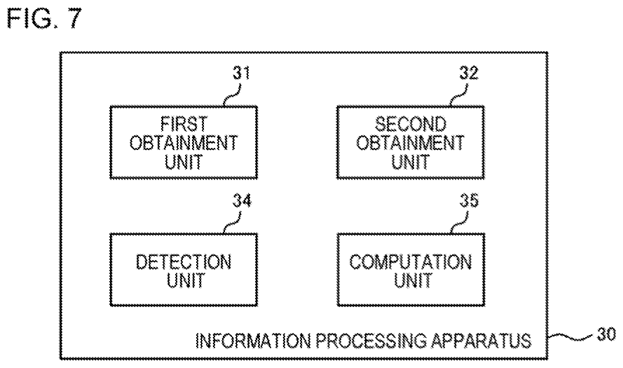

FIG. 7 is an example of still another functional block diagram of the information processing apparatus 30 according to the present example embodiment. As shown in the drawing, the information processing apparatus 30 includes the first obtainment unit 31, the second obtainment unit 32, the detection unit 34, and the computation unit 35. Configurations of the first obtainment unit 31, the second obtainment unit 32, the detection unit 34, and the computation unit 35 are the same as those of the first to the third example embodiments. It should be noted that, an example of a hardware configuration of the information processing apparatus 30 is the same as those of the first to the third example embodiments.

According to the information processing system of the present example embodiment, the same advantageous effect as the first to the third example embodiments can be realized.

Hereinafter, appendixes to examples of reference forms will be added.

1. An information processing apparatus of a second administrator, the apparatus including: a first obtainment unit that obtains first information collected by a first information collection apparatus installed over a first road managed by a first administrator; a second obtainment unit that obtains second information collected by a second information collection apparatus installed over a second road managed by the second administrator; and a notification unit that notifies the first administrator of at least one of the first information and information detected on the basis of the first information.

2. The information processing apparatus according to 1, further including: a detection unit that detects occurrence of a predetermined event on the first road on the basis of the first information; and a computation unit that computes, on the basis of the first information and the second information, at least one of a conversion rate of a traffic volume from the first road to the second road in a case where the occurrence of the predetermined event is notified to a notification target, a change in the conversion rate before and after the notification, a change in a traffic jam occurrence frequency before and after the notification, a change in a traffic jam situation before and after the notification, and a change in CO₂ concentration before and after the notification.

3. The information processing apparatus according to 2, in which the computation unit computes income of the second administrator obtained by the notification on the basis of the conversion rate.

4. The information processing apparatus according to 2 or 3, further including: a determination unit that determines a toll of the second road on the basis of the first information and the second information.

5. An information processing system including: a first information collection apparatus installed over a first road managed by a first administrator; a second information collection apparatus installed over a second road managed by a second administrator; and an information processing apparatus of the second administrator, in which the first information collection apparatus transmits collected first information to the information processing apparatus, the second information collection apparatus transmits collected second information to the information processing apparatus, and the information processing apparatus notifies the first administrator of at least one of the first information and information detected on the basis of the first information.

6. An information processing apparatus including: a first obtainment unit that obtains first information collected by a first information collection apparatus installed over a first road managed by a first administrator; a second obtainment unit that obtains second information collected by a second information collection apparatus installed over a second road managed by a second administrator; a detection unit that detects occurrence of a predetermined event on the first road on the basis of the first information; and a computation unit that computes, on the basis of the first information and the second information, at least one of a conversion rate of a traffic volume from the first road to the second road in a case where the occurrence of the predetermined event is notified to a notification target, a change in the conversion rate before and after the notification, a change in a traffic jam occurrence frequency before and after the notification, a change in a traffic jam situation before and after the notification, and a change in CO₂ concentration before and after the notification.

7. An information processing method executed by a computer of a second administrator, the method comprising: a first obtainment step of obtaining first information collected by a first information collection apparatus installed over a first road managed by a first administrator; a second obtainment step of obtaining second information collected by a second information collection apparatus installed over a second road managed by the second administrator; and a notification step of notifying the first administrator of at least one of the first information and information detected on the basis of the first information.

8. A program for causing a computer of a second administrator to function as: a first obtainment unit that obtains first information collected by a first information collection apparatus installed over a first road managed by a first administrator; a second obtainment unit that obtains second information collected by a second information collection apparatus installed over a second road managed by the second administrator; and a notification unit that notifies the first administrator of at least one of the first information and information detected on the basis of the first information.

9. An information processing method caused by a computer, the method comprising: a first obtainment step of obtaining first information collected by a first information collection apparatus installed over a first road managed by a first administrator; a second obtainment step of obtaining second information collected by a second information collection apparatus installed over a second road managed by a second administrator; a detection step of detecting occurrence of a predetermined event on the first road on the basis of the first information; and a computation step of computing at least one of a conversion rate of a traffic volume from the first road to the second road in a case where the occurrence of the predetermined event is notified to a notification target, a change in the conversion rate before and after the notification, a change in a traffic jam occurrence frequency before and after the notification, a change in a traffic jam situation before and after the notification, and a change in CO₂ concentration before and after the notification, on the basis of the first information and the second information.

10. A program for causing a computer to function as: a first obtainment unit that obtains first information collected by a first information collection apparatus installed over a first road managed by a first administrator; a second obtainment unit that obtains second information collected by a second information collection apparatus installed over a second road managed by a second administrator; a detection unit that detects occurrence of a predetermined event on the first road on the basis of the first information; and a computation unit that computes, on the basis of the first information and the second information, at least one of a conversion rate of a traffic volume from the first road to the second road in a case where the occurrence of the predetermined event is notified to a notification target, a change in the conversion rate before and after the notification, a change in a traffic jam occurrence frequency before and after the notification, a change in a traffic jam situation before and after the notification, and a change in CO₂ concentration before and after the notification.

This application claims priority based on Japanese Patent Application No. 2017-144638 on Jul. 26, 2017, the disclosure of which is incorporated herein in its entirety.

1. An information processing apparatus of a second administrator, the apparatus comprising:
at least one memory configured to store one or more instructions; and
at least one processor configured to execute the one or more instructions to:
obtain first information collected by a first information collection apparatus installed over a first road managed by a first administrator;
obtain second information collected by a second information collection apparatus installed over a second road managed by the second administrator; and
notify the first administrator of at least one of the first information and information detected on the basis of the first information.

2. The information processing apparatus according to claim 1,
wherein the processor is further configured to execute the one or more instructions to:
detect occurrence of a predetermined event on the first road on the basis of the first information; and
compute, on the basis of the first information and the second information, at least one of a conversion rate of a traffic volume from the first road to the second road in a case where the occurrence of the predetermined event is notified to a notification target, a change in the conversion rate before and after the notification, a change in a traffic jam occurrence frequency before and after the notification, a change in a traffic jam situation before and after the notification, and a change in CO₂ concentration before and after the notification.

3. The information processing apparatus according to claim 2,
wherein the processor is further configured to execute the one or more instructions to compute income of the second administrator obtained by the notification on the basis of the conversion rate.

4. The information processing apparatus according to claim 2,
wherein the processor is further configured to execute the one or more instructions to determine a toll of the second road on the basis of the first information and the second information.

5.-6. (canceled)

7. An information processing method executed by a computer of a second administrator, the method comprising:
obtaining first information collected by a first information collection apparatus installed over a first road managed by a first administrator;
obtaining second information collected by a second information collection apparatus installed over a second road managed by the second administrator; and
notifying the first administrator of at least one of the first information and information detected on the basis of the first information.

8. A non-transitory storage medium storing a program for causing a computer of a second administrator to:
obtain first information collected by a first information collection apparatus installed over a first road managed by a first administrator;
obtain second information collected by a second information collection apparatus installed over a second road managed by the second administrator; and
notify the first administrator of at least one of the first information and information detected on the basis of the first information.

9.-10. (canceled)
